(19) United States
(12) Patent Application Publication
(10) Pub. No.: US 2018/0352755 A1
(43) Pub. Date: Dec. 13, 2018

(54) Modular LED Grow Light System to Optimize Light Distribution and Integrate Natural Light

(71) Applicants: Charles Attila Szoradi, Wayne, PA (US); Glenn Stewart Baker, Paoli, PA (US)

(72) Inventors: Charles Attila Szoradi, Wayne, PA (US); Glenn Stewart Baker, Paoli, PA (US)

(73) Assignee: Independence LED Lighting, LLC, Wayne, PA (US)

(21) Appl. No.: 15/616,522

(22) Filed: Jun. 7, 2017

(51) Int. Cl. A01G 9/20; F21V 29/74; F21K 9/272; F21K 9/278; F21V 23/06

(52) U.S. Cl. CPC A01G 9/20; F21V 29/745; F21Y 2103/10; F21K 9/278; F21V 23/06; F21K 9/272

(57) ABSTRACT

This invention provides a cost-effective means for both indoor and greenhouse farmers to use a Modular Light Emitting Diode (LED) Grow Light System to optimize light distribution and integrate natural light. The Modular LED Grow Light System consists primarily of multiple narrow “Linear Modules” connected to two “End Housings” with structure from “Support Braces” that together form each “Grow Rack” within the system. The Linear Modules are longer than their diameter, and the spacing between the Linear Modules is greater than their diameter. This creates spaces between each Linear Module with three primary advantages: more even light distribution, more integration of natural light, and more air flow for natural ventilation.

### CROSS REFERENCE TO RELATED APPLICATION

The present application claims priority to U.S. Provisional Application No. 62/182,323 filed Jul. 6, 2016, the entire contents of which are incorporated herein by reference.

### FIELD OF INVENTION

The present invention generally relates to optimizing Light Emitting Diode (LED) technology to grow plants in indoor environments and greenhouses with soil, hydroponic, or aquaponic planting beds for vegetables, fruits, and flowers in addition to medicinal and biofuel products. This invention is ideal for large scale commercial planting operations, such as horizontal water based hydroponic or aquaponic systems as well as vertical planting operations that typically includes shelving racks or armatures.

### BACKGROUND OF THE INVENTION

LED lights use less energy than traditional forms of illumination and include options for custom wavelengths, providing cost-effective opportunities for indoor farming. In addition, controlled indoor farming reduces the need for pesticides and provides geographic opportunities for farming that are not reliant on outdoor climate conditions and seasonality. These factors increase the affordability of local organic farming in part by reducing the transportation distance from farm to table. LEDs also have a lower operating temperature than traditional lights, so growers can place the LEDs closer to the plants than traditional lights without as much risk of burning the leaves.

### Optimize Light Distribution:

To date, farmers that choose to grow indoors have had choices from a range of different types of technologies. The majority of traditional grow lights, such as incandescent, high intensity discharge (HID), fluorescent, and induction, include light fixtures that distribute the light from a concentrated source like light bulb fixtures or multi-tube fixtures. The lighting typically delivers a higher level of output directly underneath the fixtures with reductions in output as the horizontal distance from the centerline directly under the fixture increases. The light reduction fosters uneven growth patterns given that perimeter plants receive less of the Photosynthetic Active Radiation (PAR) that is used for growth via photosynthesis. While the latest generation of LED technology offers energy-efficiency and customizable wavelengths to match the needs of particular plants at particular growth phases, LED fixtures have presented these same challenges of concentrated light vs even distribution as previous forms of lighting technology. The adverse effects of concentrated light increase as the fixtures are placed closer to the top canopy of the plants. As fixtures are mounted higher, the concentration of PAR reduces, requiring higher output fixtures and thus added electricity cost. This invention addresses the challenge of cost-effective, even light distribution.

### Integrate Natural Light:

To date, farmers with greenhouses have relied on natural light to grow plants, and farmers with indoor facilities, lacking natural light, have mounted light fixtures in the ceilings to grow the plants. Light fixtures typically have a housing that blocks light, so greenhouse farmers are often limited in their ability to grow plants on overcast days and at night given the cost of installing and then moving lights out of the way of the advantageous sunlight for daytime growth. Installing ceiling tracks and lights with manual or motorized motion are often cost-prohibitive. This invention addresses the challenge of cost-effective natural light integration.

### SUMMARY OF THE INVENTION

An embodiment of the present invention provides a lighting assembly, comprising at least one linear module having a width and length in the plane of the lighting assembly, where the length is larger than the width. Each module comprises at least one solid state lighting (SSL) device in thermal communication with a heat sink, which provides structural support to the module. The first and second end housings have multiple sockets, and at least one of the two end housings includes at least one power supply to electrically energize the SSL device. The lighting assembly may include multiple linear modules spaced along the end housings to distribute light evenly across any given surface while allowing air to move between the modules as well as natural light when used in applications such as a greenhouse or a facility with skylights.

### BRIEF DESCRIPTION OF THE DRAWINGS

FIG. 1 illustrates the cross section of the Linear Module. The components in this example include a deep fin heat sink for maximum thermal management, channels for the printed circuit board, a surface mounted diode, and a lens cover. The arrows indicate the ability to rotate the Linear Module to either side. Situations may arise where growers may want to reduce PAR waste at the perimeter of planting beds by angling the outer edge Linear Modules toward the planting bed rather than the default angle straight down.

FIGS. 2, 3, and 4 illustrate the cross section of the End Housing. At least one side of the End Housing includes the LED Driver. Options consist of connecting the LED Driver to smart controls including but not limited to Wifi, Dimming, Day and Night switching, and other “brain” functions that integrate with sensors for measurements such as water temperature, soil moisture levels, and plant growth heights. The compression socket is typically only needed on one side, but the system includes options to have LED Drivers on both sides if and when the density of Linear Modules dictates more drivers than one End Housing can hold. The dashed lines in FIG. 2 illustrate the Structural Braces and clamps that secure them to the End Housings.

FIG. 5 illustrates a plan view of two Grow Racks, in this example 4′×8′ each, with 4 Linear Modules each, placed side by side to demonstrate the even spacing of the Linear Modules within each fixture and across the combination of the two Grow Racks. The dashed lines illustrate the Support Braces.

FIG. 6 illustrates a plan view of 32 Grow Racks, in this example 4′×8′ each, with 4 Linear Modules each, placed side by side and end to end, to demonstrate the even spacing of the Linear Modules across a commercial scale planting bed that is approximately 16′×64′.

FIGS. 7, 8, and 9 illustrate a cross section of the Grow Racks with the integration of natural light and optional reflectors. The Grow Racks in these figures are hung from the ceiling of a greenhouse with thin cables, such as aircraft cables, to minimize shadowing and maximize the natural light to the plants. The reflectors increase the amount of natural light reaching the plants when the sun is at low angles during sunrise and sunset. A larger scale of the reflector cross section is included in FIG. 12.

FIG. 10 illustrates a cross section of the Grow Rack with the optional reflectors that are engineered for grow operations that will benefit from concentrated beam angles over the top of planting rows or at the edge of planting beds to reduce PAR waste. The reflector cross section is included at a larger scale in FIG. 13.

FIG. 11 illustrates a cross section of the Grow Rack with the arrows representing the air-flow through Linear Modules. Warm air rises and reduces heat gain on the plants through convection loops.

FIG. 12 illustrates a cross section of the reflector engineered for natural light integration in greenhouses or indoor grow facilities with skylights or natural light through windows or clearstories. The arrows reflect the air-flow from underneath the reflector. Warm air rises and reduces the heat gain on the plants through convection loops. The reflectors may be either straight in a vertical position as well as optional, concave, convex, or prismatic to amplify the light.

FIG. 13 illustrates a cross section of the reflector engineered for narrow beam angles. The arrows reflect the air-flow from underneath the reflector. Warm air rises up and reduces the heat gain on the plants through convection loops. The reflectors may either be straight and set at an angle or optional, concave, convex, or prismatic to amplify the light. These reflectors create a “lobe” effect to increase the output of light relative to certain types of plants.

FIG. 14 illustrates a cross section of multiple Grow Racks with the installations set at elevation levels that step up as the plants grow to maintain optimal levels of PAR along the directional path of a hydroponic or aquaponic pool with planting rafts.

FIG. 15 illustrates a perspective view of a hydroponic or aquaponic pool with planting rafts and a cross section of multiple Grow Racks.

FIG. 16 illustrates an elevation view of two side-by-side 4′ End Housings with the circles indicating the socket options for the Linear Modules. One option is to space the sockets so that it is equal across the system when the End Housings are installed side by side. This further contributes to even PAR distribution over large scale planting beds.

FIG. 17 illustrates multiple elevations of the End Housings with a range of options for filling the sockets with the Linear Modules. The circles in outline are the ones without the Linear Modules, and the circles filled in are the ones with the Linear Modules. The density in this example at 4′ length End Housings and 3″ socket spacing is one Linear Module at the lowest density up to 16 Linear Modules for the highest density.

FIG. 18 illustrates examples of common configurations of the Grow Racks with different densities of Linear Modules from left to right at 8′, 7′, 6′, 5′, and 4′. From bottom to top, the Grow Racks have 4 Linear Modules, 8 Linear Modules, and 18 linear Modules over the 4′ length of each End Housing. Growers can choose their configuration to match the size of their planting beds. Growers can easily decrease the lighting density by removing one or more Linear Modules without any tools. This removal can be done given the compression sockets or a shift in the location of the Linear Modules within the socket locations. Growers can change the wavelength mix in certain areas of their grow operation by ordering different wavelength Linear Modules and exchanging them without any tools. Many plants have different photosynthetic needs during different growth phases so this flexibility provides an opportunity for growers to optimize the Grow Racks to produce the highest yield. Growers can increase lighting density by ordering additional Linear Modules at their discretion or by ordering different length Linear Modules and using the same End Housings. Longer Linear Modules use more electricity than shorter ones, so the LED Drivers in the End Housings need to match accordingly.

FIG. 19 illustrates a vertical rack with multiple grow beds. The Linear Modules in this example are at the top of each rack to deliver the PAR to the plants at floor level and at each level of the rack. This figure illustrates the shelving as transparent to highlight the location of the Linear Modules. The rack systems typically include metal structure with plywood, metal, or plastic trays in the case of hydroponic and aquaponic farming. The height of the racks and the distance from the plants to the LEDs are tailored subject to the type of plant, growth pace and harvest height.

FIG. 20 illustrates a 4′×8′ grow area with illumination from a Grow Rack with 6 Linear Modules at the top.

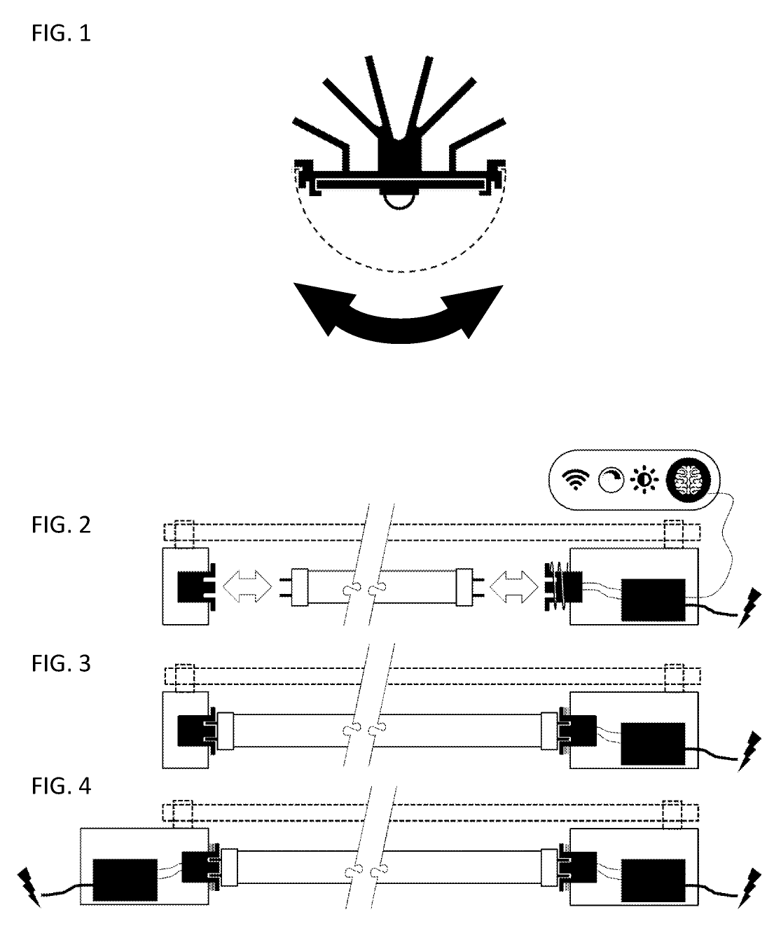

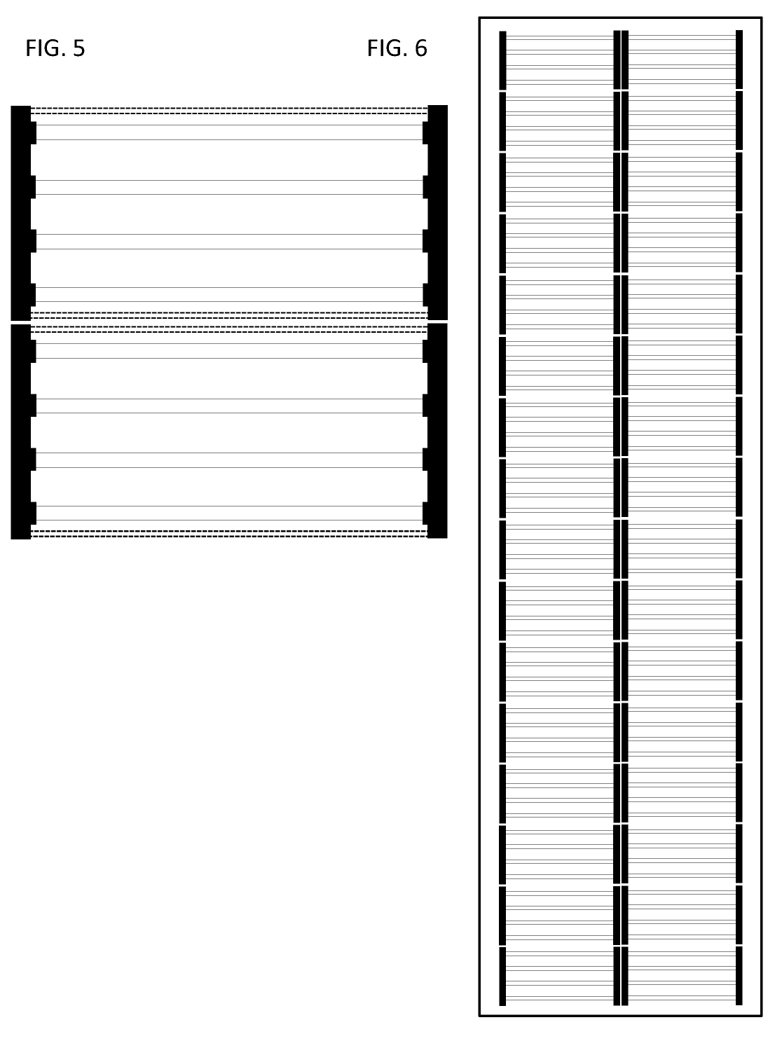

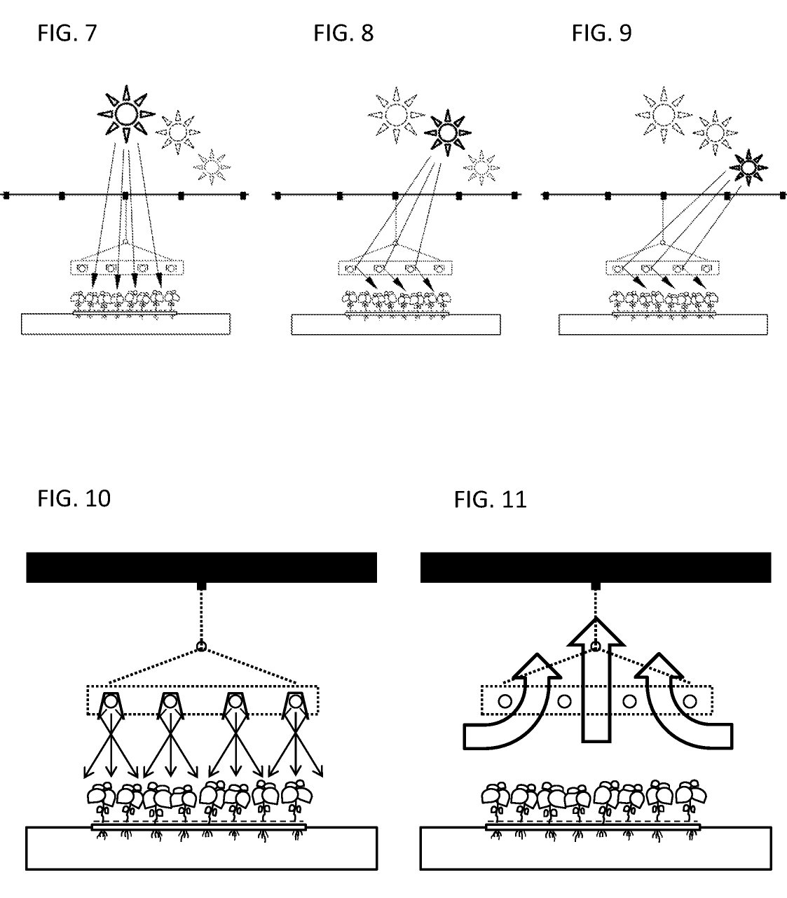

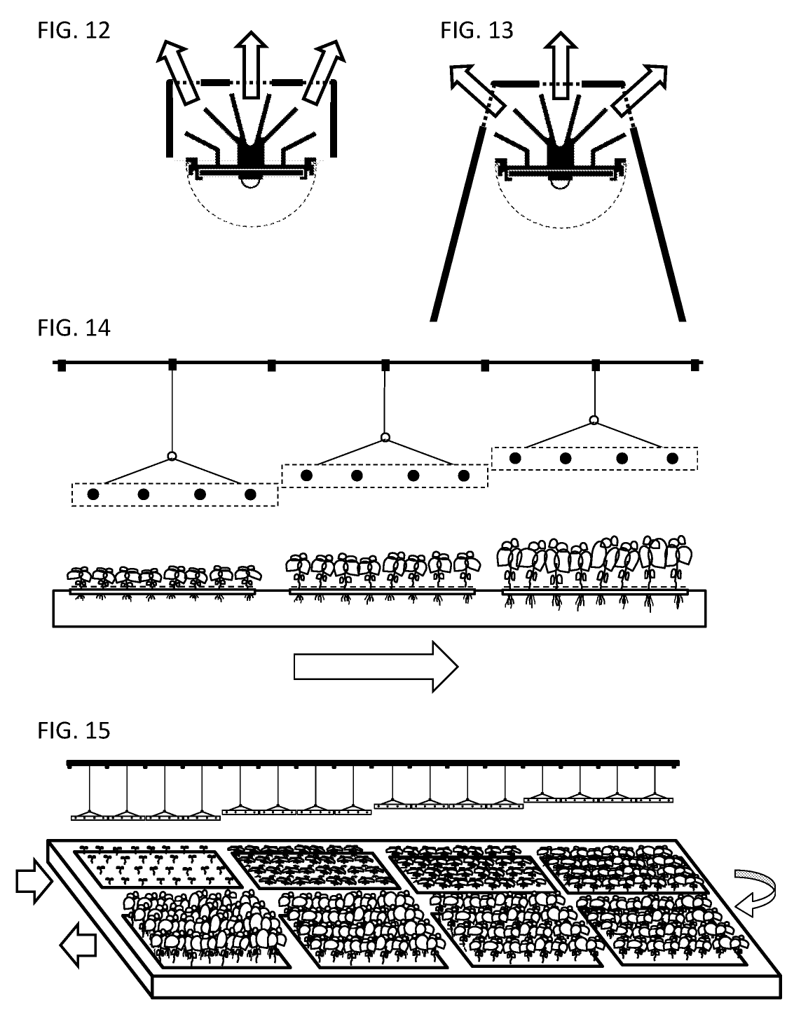

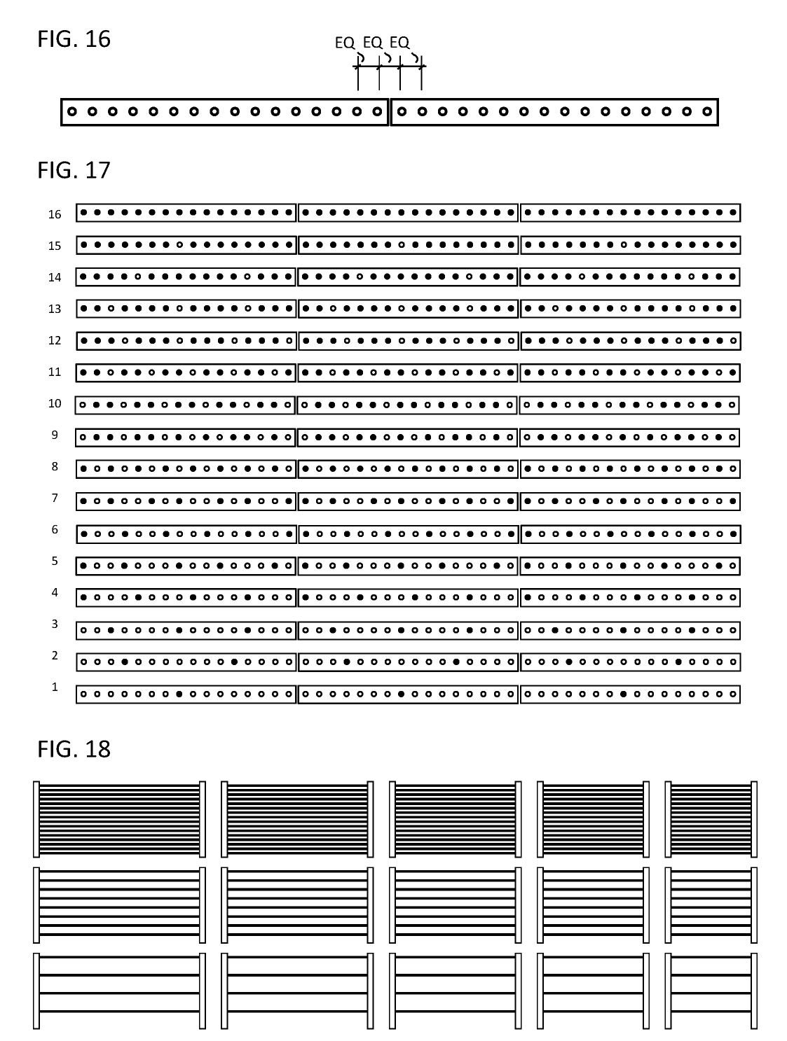

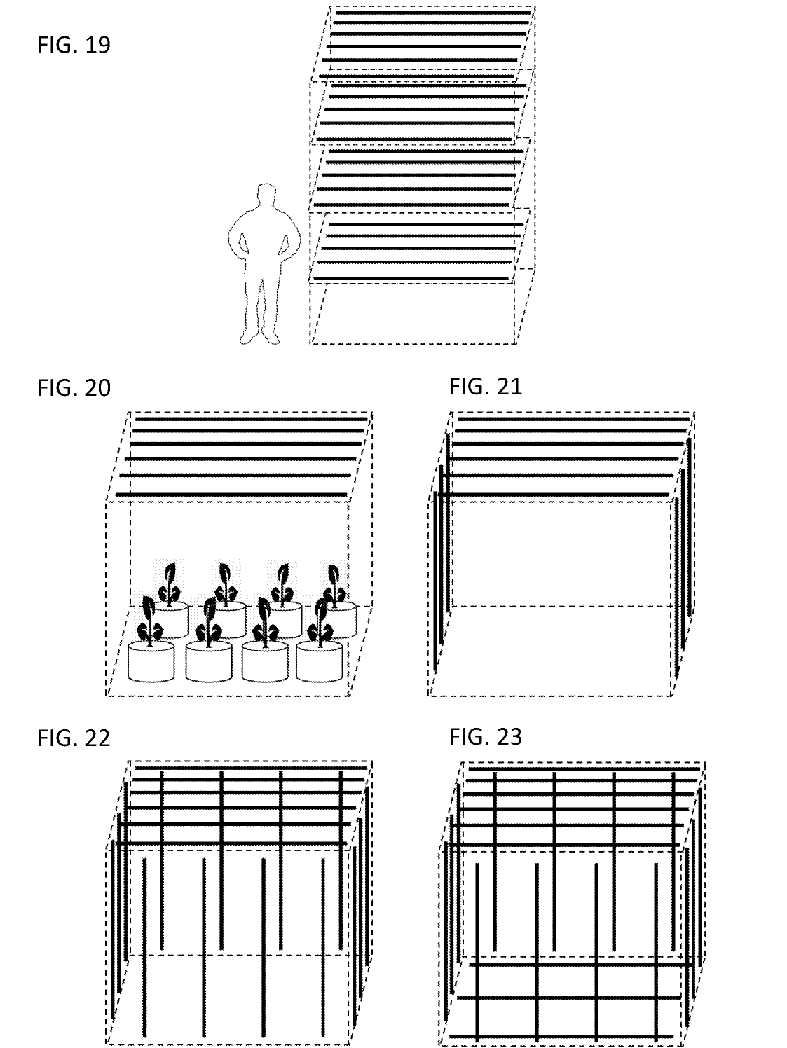

FIG. 21 illustrates a 4′×8′ grow area with illumination from a Grow Rack with 6 Linear Modules at the top, plus:
Short Sides: 4′×6′ Tall (3 Modules)

FIG. 22 illustrates a 4′×8′ grow area with illumination from a Grow Rack with 6 Linear Modules at the top, plus:
Short Sides: 4′×6′ Tall (3 Modules)
Long Sides: 4′×6′ Tall (2 Modules×2)

FIG. 23 illustrates a 4′×8′ grow area with illumination from a Grow Rack with 6 Linear Modules at the top, plus:
Short Sides: 4′×6′ Tall (3 Modules)
Long Sides: 4′×6′ Tall (2 Modules×2)
Bottom (up light) 4′×8′ (3 Modules)
   Note: Certain plants may benefit from PAR delivery to the underside of the leaves.

FIGS. 24, 25, and 26 illustrate the application of the Linear Modules, Grow Racks, and reflectors into Tractor Trailer and Shipping Containers.

FIG. 27 illustrates the application of the Linear Modules, Grow Racks, and reflectors into a Perpetual Food Machine. The system includes the integration of multiple technologies that together create a new generation of food production. In this case the fish used on the system are herbivores, such as tilapia, where some portion of the food grown is for the fish. The fish waste provides nutrients for the plants in this eco-system. This overall system includes options for reflectors at the perimeter of planting beds to reduce PAR waste reduction. The perimeter reflectors are sized based on photometric analysis of the needs of any given grow operation. As an example vertical reflective curtains can work to contain the light in the planting bed. FIG. 27 includes dash/dot lines running vertically on either side of the planting bed. In this example, a retractable curtain with a flexible material such as Mylar would contain the PAR but allow the farmer to cultivate and harvest the plants by raising the curtain like a retractable window shade or sliding the curtain to the side such as in the case of a ring system at the top of a shower curtain.

### DETAILED DESCRIPTION OF THE INVENTION

This invention creates spaces between each Linear Module with three primary advantages: more even light distribution, more integration of natural light, and more air flow for natural ventilation. The heightened air-flow increases the ability to place the LEDs closer to the plants and reduces the electricity operating costs. The system includes optional smart controls, optics, and reflectors on the Linear Modules or at the perimeter of planting beds to reduce light waste. This system includes multiple forms of technology that can be used independently or in conjunction with each other to optimize plant growth. This invention is more than a light fixture; it is a system of illumination that has the ability to scale from small to large applications, enhance different types of horizontal and vertical grow facilities, and adjust to the specific needs of the growers and their plants prior to installation as well as after installation.

Linear Modules: The Linear Modules consist primarily of an extruded heat sink that serves as the structural spine, LEDs mounted on a printed circuit board, a lens, and two end caps. The linear modules are typically between 1″ and 1.5″ in diameter and between 4′ and 8′ in length.

End Housings: The End Housing consists of a containment structure, made of material such as sheet metal, that encloses the external LED drivers and includes multiple sockets to power the Linear Modules. The End Housing is typically 4′ in length with a width and height of several inches to accommodate the size of the LED Driver and accommodate the diameter of the socket. The End Housing includes sockets spaced evenly along the length, perhaps every 3″, to maintain flexibility for the lighting provider, or the grower, to adjust the lighting density or install different wavelength Linear Modules. The End Housings on at least one side also include optional compression sockets for easy exchange of Linear Modules without the need for any tools by the grower after the system is installed.

Support Braces: The Support Braces secure the End Housings at the distance appropriate to the length of the Linear Modules selected for the particular Grow Rack. In some cases, a conduit pipe is used and secured at either end to the End Housings with brackets. The conduit pipe can also house wiring for the Grow Racks with LED Drivers in both End Housings.

Smart Controls: Optional Smart Controls improve the performance of the Grow Racks within the system. For greenhouse farmers, natural sunlight is a free and renewable resource. This invention takes advantage of the ability for sunlight to support plant growth with minimal shadowing from the LEDs. On sunny days, the sun provides the Photosynthetic Active Radiation (PAR) to grow the plants by day, and at night, the LEDs provide supplemental PAR to increase growth and decrease time to harvest. The LEDs are turned on through manual switches, timers, or computer smart control systems. This invention includes optional dimmable LED drivers. One of the advantages of dimming is to deliver partial supplemental light on overcast days versus “on/off” output. This form of light harvesting uses optional photocells to add LED light during all or portions of overcast days to maintain target PAR values across the grow period. An additional advantage of dimming is to mimic sunrise and sunset to provide a double grow shift over any season, including winter months, when less natural light is available. For non-greenhouse indoor farmers, the smart controls and dimming are also advantages to increase plant growth.

### Applications for the Invention:

### Horizontal Grow Operations:

To date, some commercial indoor farmers have transitioned from using soil to water pools to grow their plants. The pools are typically relatively shallow with a minimum of a few inches of water in depth to allow enough room for the roots to grow in the water. The seedling plants are typically placed in holes in floating platforms, sometimes referred to as “rafts.” See FIGS. 14 and 15. Farmers that use waterbeds for vertical grow shelving structures typically leave the rafts in a stationary position and harvest the plants from the perimeter of the shelving structures. Farmers that use waterbeds for horizontal growth pools often add rafts loaded with seedling plants to the pool at one end and remove the mature plants ready to harvest at the other end. This means that the plants are in motion floating along a horizontal “conveyor belt.” Indoor farmers are often limited in their ability to raise lights as plants grow, resulting in either too much light or not enough light subject to the hanging height of the fixtures over the canopy of young vs. mature plants.

This invention helps maximize horizontal grow operations through optimized light density and natural light integration as well as “step up” illumination. FIGS. 14 and 15 illustrate how the LEDs step up as the plants move in planting rafts along the flotilla. This allows the LEDs to provide the ideal amount of light for photosynthesis at the optimal distance above the top leaves of the plants without the need for the grower to raise the LEDs as the plants grow. As the plants grow they are moving into the areas that have the higher LEDs. The plants move rather than the LEDs. The same step up approach for this invention works with soil based farming if the growers use rolling racks or rolling planting trays.

### Vertical Grow Operations:

Planting density is a priority for growers in areas like metro markets where the cost per square foot of real estate is high, either to purchase or lease facilities. Rack systems maximize the grow yield per square foot. The larger the number of shelving racks for any given vertical distance, the more product the grower can produce. This system increases the number of grow racks, because the air circulation through the Linear Modules and the even light density allows the grower to place the LEDs closer to the plant. See FIG. 18 for an example of a vertical Grow Rack, and see FIGS. 23, 24, and 25 for examples of vegetables such as micro-greens grown in a Tractor Trailer or Shipping Container.

### Mobile and Container Grow Operations:

This system reduces the distance from farm to table by providing growers the ability to connect the supply with demand in local markets through indoor farming. The Tractor Trailer or Shipping Container example in FIGS. 23, 24, and 25 is to demonstrate two points:
1. Mobile Grow Operations can help educate grade school, high school, and college age students about the advantages of LED technology to create fresh, local, and organic food. Instead of field trips for a school to a grow operation, this technology can bring the grow operation to showcase at the schools.
2. Container Grow Operations. Certain end users such as schools may not have enough real estate to set up an area to grow their own vegetables. Shipping Containers typically come in about 8.5′ tall by 8′ wide units that are either 20′ or 40′ in length. This system works to produce food in Shipping Containers that can be left on side adjacent to an existing building or at the edge of a parking lot. For schools, the intent is to use this system either in the existing buildings or in the containers to teach Science, Technology, Engineering, and Math (STEM) in addition to providing fresh vegetables for the students. This same container concept applies for underserved communities where fresh vegetables are not readily available and the community center could house the system in the building or in the container.

### Sustainable Grow Operations—Perpetual Food Machine:

FIG. 27 illustrates the integration of multiple technologies that together create a new generation of food production. In this case the fish used on the system are herbivores, such as tilapia, where some portion of the food grown is for the fish. The fish waste helps provide the nutrients for the plants in this eco-system. The Linear Modules and the advantages of the Grow Racks increase the performance of this system that can be used for food production as well as education of Science, Technology, Engineering, and Math (STEM) in schools. Given that this system uses 90% less water than traditional farming and draws renewable solar power, it is well suited for many areas of the developing world. Given the output of oxygen, this Perpetual Food Machine is also ideal for space travel and establishing sustainable life support on planets such as Mars.

### Technology Integration:

### Solar Photovoltaic (PV) Technology:

This invention includes optional solar power. Solar cells are a current source. When the photon hits the cell it generates a current. Typically, an inverter transforms the DC source current for use as AC either on site or fed into the electricity grid for net metering with utility companies. The AC to DC power conversion carries with it a power loss of approximately 10% to 12%. This invention includes DC direct power modules to deliver the DC power directly to the LED-LMs and bypasses the need for the localized power modules on each LED-LMs. This solar direct grow light aspect of the invention has the capability to increase efficiency by over 20%, given the combined advantages of eliminating the AC to DC power conversion waste. Beyond energy savings, this aspect of the invention is well suited for developing countries that may have available sunlight without access to grid power electricity.

### Direct Circuit (DC) Power:

Traditional lights are most commonly powered through Alternating Current (AC), but LEDs are powered by Direct Current (DC). The vast majority of LEDs include either internal or external drivers that convert AC to DC power. The AC to DC power conversion carries with it a power loss of approximately 10% to 12%. This invention includes DC power modules to reduce the operating cost of the LEDs further below the operating cost of traditional lamps. This invention includes DC powered pumps for water circulation to further increase energy efficiency over AC powered pumps.

### LED Lighting Smart Controls

On/Off: The external driver technology of the LEDs in this invention includes the ability to program, through a smart control mechanism, the power on/off cycles to optimize plant growth over multiple growth sessions within a 24 hour period, based on the different types of plants.

Dimming: The external driver technology of the LEDs in this invention includes the ability to program, through a smart control mechanism, dimming to simulate sunrise and sunset to optimize plant growth over multiple growth sessions within a 24 hour period, based on the different types of plants.

Elevation: The suspension hanging systems, typically on cables or chains, of the LEDs in this invention include the ability to program, through a smart control mechanism, the elevation of the light source to optimize plant growth over a given day or the entire growth period based on the different types of plants.

### Seedling to Harvest:

FIG. 15 illustrates how this invention enhances a horizontal journey via a flotilla with planting rafts or a rolling rack system. The removal of harvest ready plants at the end of the planting path makes room for the seedling plants. This system works well for a linear path and is optimized by creating a return path so that the farmer can service the unloading of the harvest ready plants at the same end as the loading of the seedlings.

### Biochar and Peat Moss

This invention enhances the grow cycle and includes the optional smart controls to measure data such as soil content. Nutrient supplements such as biochar for soil systems as well as hydroponic and aquaponic systems are one of the components to enhance growth. Biochar is the solid material obtained from the carbonization of biomass. Biochar is often added to soils with the intention of improving soil function, plant growth, and reducing emissions from biomass that would otherwise naturally degrade to greenhouse gases. Biochar also has appreciable carbon sequestration value. This invention integrates optional biochar in the water based conditions as well as soil conditions because certain types of biochar have the ability to hold nutrients and enhance the total growth system. For soil-based conditions this invention also includes options for traditional peat moss and peat moss replacement made from recycled newspaper or cellulose materials and organic additives.

### Harvest Techniques:

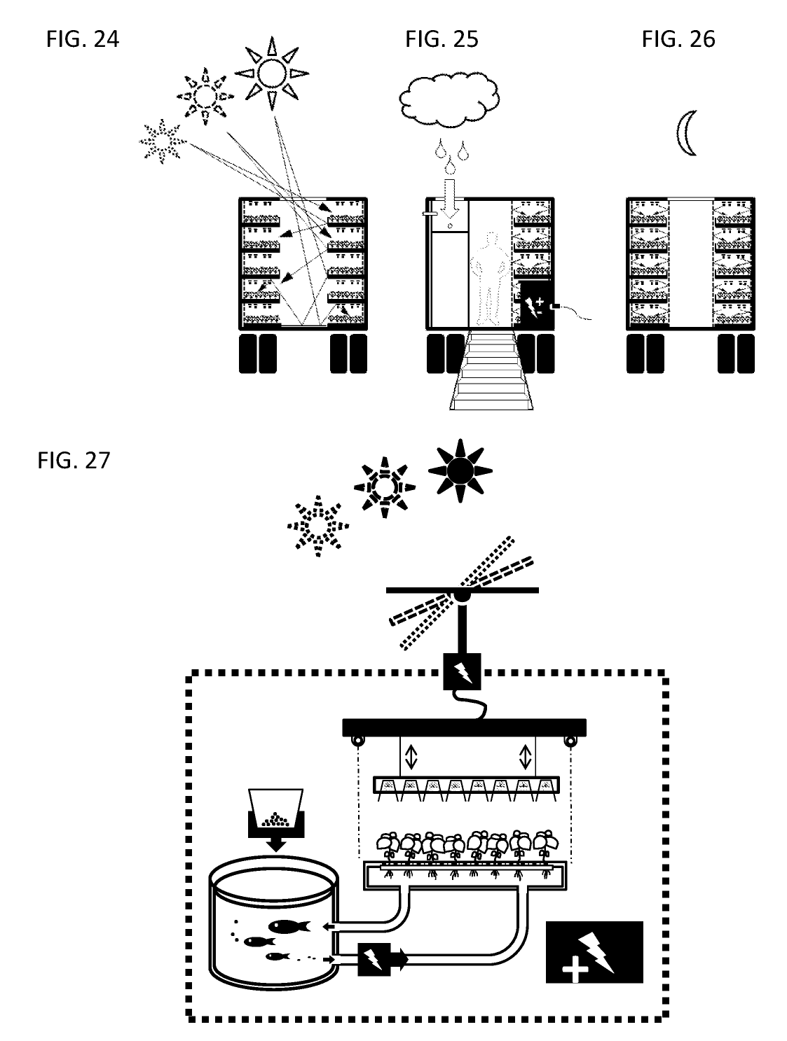

Some indoor farmers harvest organic materials in their entirety with the roots to make room for the new seedling rafts or soil based planting trays. In contrast, others harvest the leaves, such as basil for pesto, or the yield from mature plants, such as tomatoes, over multiple harvest cycles across a season. The “step up” aspect of this invention along the growth path is best suited for the farmers that harvest the full plants. Placing the Grow Racks in both horizontal and vertical positions, as in FIGS. 20, 21, 22, and 23 illustrate ways to maximize plant growth. Some growers have started experimenting with the advantages of diagonal plant beds that have a tiered stair structure. They found that Grow Racks function well in diagonal positions in addition to vertical and horizontal orientation. This example of flexibility is a reflection of the scalability of the Modular LED Grow Light System to Optimize Light Distribution and Integrate Natural Light across a broad range of agriculture needs and applications.

Notes: “linear” will be defined to mean “one-dimensional” to allow for straight or curved module sections. “one dimensional” will be defined to mean L/t>10, where L is the length of the module. “at least one” is claimed, as opposed to “a plurality”, because the prior art does not teach a single module with extended end housings having a plurality of sockets to enable expandability and flexibility of function. printed circuit board is not necessary, since the SSL might be an OLED, or LEDs might be directly mounted to the heat sink. “lens” has been omitted, since it's not necessary to the basic invention, but will be added toward the preferred embodiment. the heat sink does not have fins—add them later. the power supply is not necessarily connected to the mains or to any external connection, thereby allowing for an integral power source such as a battery or solar cell.

What is claimed is:

1. A lighting assembly, comprising: at least one linear module having a width in the plane of the lighting assembly, w, and having a length in the plane of the lighting assembly, L, where L/w>10; each module comprising: at least one solid state lighting (SSL) device in thermal communication with a heat sink, said heat sink providing structural support to the module; first and second end housings each comprising a plurality of sockets; wherein a first end of each of the at least one module is physically and electrically connected to a socket in the first end housing and the second end of each of the at least one module is physically and electrically connected to the second end housing, and wherein at least one of the two end housings includes at least one power supply to electrically energize the at least one SSL device.

2. The lighting assembly of claim 1, comprising at least two module sections parallel to each other in the plane of the lighting assembly, and spaced apart by a minimum distance, d, where d/w>1.

3. The lighting assembly of claim 1, comprising at least two module sections parallel to each other in the plane of the lighting assembly, and spaced apart by a minimum distance, d, where d/w>2.

4. The lighting assembly of claim 1, comprising at least two module sections parallel to each other in the plane of the lighting assembly, and spaced apart by a minimum distance, d, where d/w>4.

5. The lighting assembly of claim 1, wherein at least one linear module section is straight.

6. The lighting assembly of claim 1, wherein the at least one linear module sections are curved.

7. The lighting assembly of claim 1, wherein the at least one SSL device comprises at least one of:
inorganic LEDs, organic LEDs (OLEDs), polymer LEDs (PLEDs), flexible LEDs (FLEDs), phosphor-based LEDs, quantum dot LEDs, or laser diodes.

8. The lighting assembly of claim 1, wherein the at least one SSL device is thermally attached to a thermally conducting substrate, including a thin dielectric is r and a conductive layer with a plurality conductive members as part thereof, which is thermally attached to the heat sink.

9. The lighting assembly of claim 1, wherein the heat sink includes at least one heat fin, defined as an enhancement of the surface area of the heat sink providing advantages of heat dissipation by convection and radiation, as well as structural rigidity.

10. The lighting assembly of claim 1, wherein one or more of the SSL devices communicates optically with an optical element to distribute the light into different angles or locations, with optical element defined as a refractive, reflective, or diffractive component that distributes the light from an LED into a more beneficial angular or spatial distribution.

11. The lighting assembly of claim 1, wherein the at least one linear module section and the first and second end housings form a positive angle between them.

12. The lighting assembly of claim 10, wherein the positive angle between them is approximately 90 degrees.

13. The lighting assembly of claim 1, wherein one linear module between the two end housings forms an “H” shaped configuration.

14. The lighting assembly of claim 1, wherein the at least one linear module section and the first and second end housings provide for interchangeably removing or replacing the at least one linear modules into a different socket without the need to disconnect the power to the lighting assembly or disrupt the power to the other linear modules.

15. The lighting assembly of claim 1, wherein control data paths operatively connected to one or more of the sockets on at least one of the end housings with the socket providing the electricity to the linear module upon compression and or other engagement such as a slot and rotate configuration.

16. The lighting assembly of claim 1, wherein the plane of the lighting assembly is horizontal, or vertical, or any angle in between, relative to the direction of gravity.

17. A lighting system comprising a plurality of lighting assemblies of claim 1, wherein the planes of the lighting assemblies are parallel to each other.

18. The lighting assembly of claim 1, comprising at least one linear module, wherein:
at least one end cap is mounted on an end of the linear module, the end cap including a port configured to receive the electrical connector that is connected to the at least one SSL device.

19. The lighting assembly of claim 1, comprising at least two end housings, each comprising a plurality of sockets, wherein the center lines of each socket are spaced apart by an equal distance, d, and the distance from the edge of the end housing unit to the socket closest to each end is approximately d/2.
